(19) United States
(12) Patent Application Publication
(10) Pub. No.: US 2016/0232176 A1
(43) Pub. Date: Aug. 11, 2016

(54) DATA SCRUBBING CERTIFICATION FOR PLATFORM TECHNOLOGIES

(71) Applicant: Empire Technology Development LLC, Wilmington, DE (US)

(72) Inventor: Ezekiel Kruglick, Poway, CA (US)

(73) Assignee: EMPIRE TECHNOLOGY DEVELOPMENT LLC, Wilmington, DE (US)

(21) Appl. No.: 14/761,935

(22) PCT Filed: Oct. 15, 2014
(86) PCT No.: PCT/US14/60773

§ 371 Date: Jul. 17, 2015

(51) Int. Cl. G06F 17/30

(52) U.S. Cl. CPC G06F 17/30156; G06F 17/30483

(57) ABSTRACT

Technologies are generally described to monitor an ingress and egress of data to and from platform provided storage. In some examples, a data scrubbing certification module of a platform may be configured to determine an existence of a data retention and elimination policy of a service associated with an application executed at the platform, where the service may store application data within a data store of the platform. The data scrubbing certification module may activate a certification process for the application, and the data store may receive the application data inserted with one or more sentinels from the service such that the data scrubbing certification module may track the sentinels to verify an ingress and egress of the application data to and from the data store. Evidence that the service is compliant with the data retention and elimination policy may then be provided to the application based on the verification.

### BACKGROUND

Unless otherwise indicated herein, the materials described in this section are not prior art to the claims in this application and are not admitted to be prior art by inclusion in this section.

Datacenter applications are increasingly moving from integrated implementations to applications composed of interconnected services. Leveraged use of existing services in datacenters such as user authentication, social information, text processing, file storage, and video processing, for example, may allow new companies and services to develop applications at lower launch costs than previously achieved. Accordingly, within the web space there is an increasing trend toward new application teams implementing concepts with most of the components composed of existing services in the datacenters.

However, the above-described trend has not occurred in platform technologies comprising sensitive data, such as in alternative payments platforms. For example, the rules for certifications and protections governing payment information may make participating in the alternative payments market an expensive proposition that currently entails a large investment and employees dedicated to collecting evidence of declared information practices. The overhead may be inconsistent with the lightweight nature of next generation web companies causing few business-intelligence, semantics, or other service companies to be capable of working with alternative payments companies, resulting in a very limited market with slow innovation.

Accordingly, current implementations for service providers associated with platform technologies comprising sensitive data could use improvements and/or alternative or additional solutions such that the service providers and platform technologies may leverage existing services of the datacenters and maintain compliance with the certifications and protections governing the sensitive data.

### SUMMARY

The present disclosure generally describes techniques to employ data scrubbing certification to monitor an ingress and egress of sensitive data to and from platform provided storage.

According to some examples, methods to monitor data ingress to and data egress from platform provided storage are provided. An example method may include determining an existence of an agreement to a data retention and elimination policy from a service associated with an application, where the service is configured to store application data within a data store of a platform, and activating a data scrubbing certification for the application. The example method may also include receiving the application data inserted with one or more sentinels from the service, and tracking the sentinels to verify an ingress of the application data to the data store and an egress of the application data from the data store.

According to other examples, systems to monitor data ingress to and data egress from platform provided storage are described. An example system may include an application comprising sensitive data, a service associated with the application, where the service is configured to store application data within a data store of a platform, and a data scrubbing certification module executed at the platform. The data scrubbing certification module may be configured to determine an existence of an agreement to a data retention and elimination policy from the service and activate a data scrubbing certification for the application. The data scrubbing certification module may also be configured to receive the application data inserted with one or more sentinels from the service, and execute an encrypted search within the data store for the sentinels to track the sentinels in order to verify an ingress of the application data to the data store and an egress of the data from the data store. The data scrubbing certification module may further be configured to provide evidence to the application that the service is compliant with the data retention and elimination policy based on the verification.

According to some examples, systems to monitor data ingress to and data egress from platform provided storage are described. An example platform may include one or more services comprising at least a data scrubbing certification module and a data store. The data scrubbing certification module may be configured to determine an existence of an agreement to a data retention and elimination policy from a service that is associated with an application, where the service is configured to store application data within the data store, and activate a data scrubbing certification for the application. The data scrubbing certification module may also be configured to generate sentinel values to execute an encrypted search within the data store using the generated sentinel values to determine whether the generated sentinel values are present in the data store, and return one or more of the generated sentinel values that are not present in the data store to the application as one or more sentinels for insertion within the application data. The data scrubbing certification module may be further configured to receive the application data with the sentinels inserted from the service, execute another encrypted search within the data store for the sentinels to track sentinels in order to verify an ingress of the application data to the data store and an egress of the application data from the data store, and provide evidence to the application that the service is compliant with the data retention and elimination policy based on the verification.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates a conceptual diagram showing an example datacenter-based system where data scrubbing certification may be implemented;

FIG. 2 illustrates a conceptual system where data scrubbing certification may be implemented;

FIG. 3 illustrates an example system to monitor data ingress to and egress from platform provided storage employing data scrubbing certification;

FIG. 4 illustrates a general purpose computing device, which may be used to monitor data ingress to and egress from platform provided storage employing data scrubbing certification;

FIG. 5 is a flow diagram illustrating an example process to monitor data ingress to and egress from platform provided storage employing data scrubbing certification that may be performed by a computing device such as the computing device in FIG. 4; and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to methods, apparatus, systems, devices, and/or computer program products related to employment of data scrubbing certification to monitor data ingress to and data egress from platform provided storage.

Briefly stated, technologies are generally described to monitor an ingress and egress of data to and from platform provided storage. In some examples, a data scrubbing certification module of a platform may be configured to determine an existence of a data retention and elimination policy of a service associated with an application executed at the platform, where the service may store application data within a data store of the platform. The data scrubbing certification module may activate a certification process for the application, and the data store may receive the application data inserted with one or more sentinels from the service such that the data scrubbing certification module may track the sentinels to verify an ingress and egress of the application data to and from the data store. Evidence that the service is compliant with the data retention and elimination policy may then be provided to the application based on the verification.

Reference is made to “datacenters” and “platforms” herein. A platform may be a datacenter and its associated services, a set of hosted services run within a datacenter by another entity, a set of services running on the same or different hardware than the application, or a set of services run on any computing hardware and providing the services described herein. A datacenter may be a physical entity comprising one or more physical servers that provide an execution and/or storage infrastructure for a number of applications, services, and/or platforms. As described below, a datacenter may enable execution of various applications, services, and/or platforms through virtual machines or servers, where a physical server may host one or more virtual machines or servers.

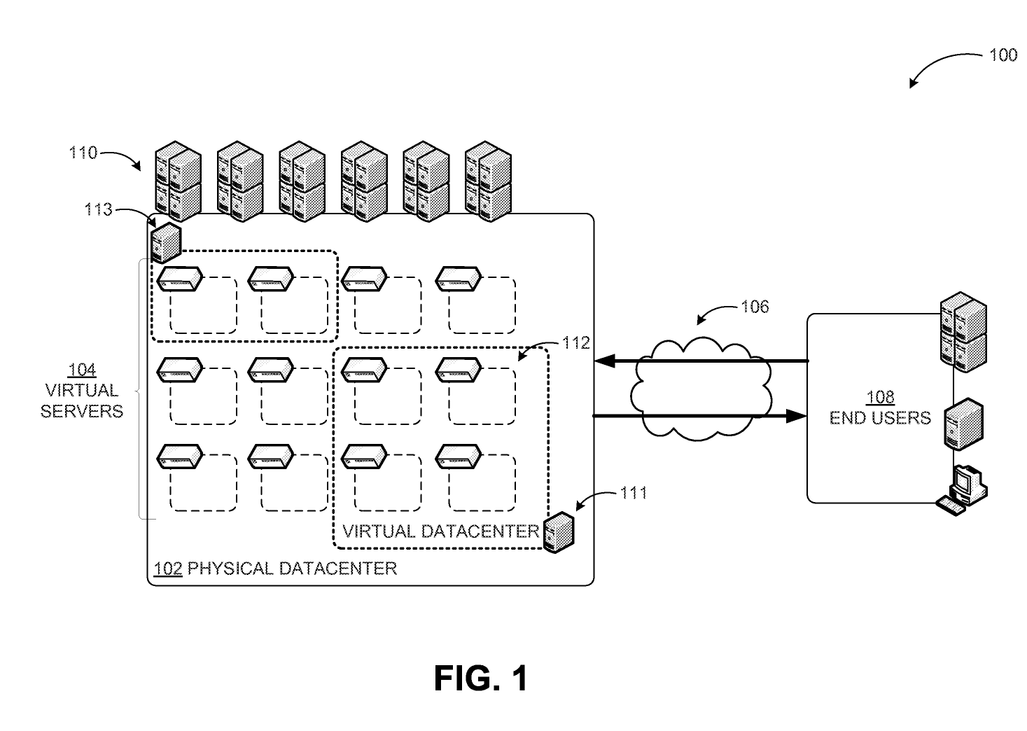

FIG. 1 illustrates a conceptual diagram showing an example datacenter-based system where data scrubbing certification may be implemented, arranged in accordance with at least some embodiments described herein.

As shown in a diagram 100, a datacenter 102 may include one or more servers 110, 111, and 113 that are physical servers associated with software and underlying hardware of the datacenter 102. The one or more servers 110, 111, and 113 may be configured to execute one or more virtual servers 104. For example, as depicted, the servers 111 and 113 may be configured to provide four virtual servers and two virtual servers, respectively. In some embodiments, one or more virtual servers may be combined into one or more virtual datacenters. For example, the four virtual servers provided by the servers 111 may be combined into a virtual datacenter 112. The virtual servers 104 and/or the virtual datacenter 112 may be configured to host a multitude of servers to provide cloud-related data/computing services such as various applications, data storage, data processing, or comparable ones to one or more end users 108, such as individual users or enterprise customers, via a cloud 106.

Datacenters may routinely offer Data Loss Prevention (DLP) services, which may be services that scan content, such as files, packets, or machine images, in transit to determine if the content includes a specific type of data, such as sensitive data. For example, many datacenters may offer a DLP service that scans outgoing application data to look for substrings that indicate financial data or other sensitive. In many cases, the DLP service may no longer be useful when an application is associated with a vendor and/or a service provider, such as a software as a service (SaaS) provider. For example, when the application is associated with the SaaS provider, there may be no technique to allow verification that the application data provided to the SaaS provider is not kept after a task is completed. Furthermore, a task that often employs the DLP service may be a type of task where the vendor is likely to employ encryption. As a result, neither the vendor nor the datacenter may be able to verify when or if the sensitive information has been removed from the vendor systems.

Working with platforms comprising sensitive data, such as the payments industry and/or the medical industry, may further include a maze of potential qualifications. Each industry standard may include control objectives, which may be goals including recommended implementations, and tests. For a service provider associated with sensitive payment or health data, relevant standards and/or certifications may include PCIDSS, ISO 27000, SAS70, SSAE-16, HIPAA, and Gramm-Leach-Bliley Act (GLBA), for example. Of those standards, ISO, SAS70, SSAE-16, HIPAA, and GLBA compliance may be satisfied by the service provider having a data retention and elimination policy and providing proof of practice. The remaining certification, PCIDSS, may not be needed for service providers that do not handle actual payment card numbers. Accordingly, two elements for compliance satisfaction may include a data retention and elimination policy and proof of practice. Two levels of demonstration of proof of practice may include interviews and evidence. Interviews may include employees being interviewed to ascertain actions they undertake in ways that comply with the data retention and elimination policy, whereas evidence may include measurable audit data related to the data retention and elimination policy, for example. Interviews may be considered weaker than evidence of compliance and as such may need to be much more comprehensive than evidence tested by a third party.

According to embodiments, a datacenter, such as the datacenter 102, may offer data scrubbing certification for an application associated with a service. Employment of the data scrubbing certification may allow a provider of the service to be compliant with relevant industry standards largely automatically by providing a data retention and elimination policy and proof of practice (implementation of the policy). The service provider may be the operator of the datacenter 102 or a third party service provider, for example. The service provider may store data on existing datacenter infrastructure and the service provider may agree to the data retention and elimination policy provided by the datacenter 102. In some examples, the datacenter 102 may act as an auditor while data scrubbing certification is implemented, and may provide evidence as proof of practice in response to a determination that the service is compliant with the data retention and elimination policy.

In an example scenario, the datacenter 102 may include one or more datacenter services including at least one data scrubbing certification module. The data scrubbing certification module may be configured to determine an existence of an agreement to a data retention and elimination policy from a service associated with an application being executed at the datacenter 102. The data scrubbing certification module may be configured to activate a data scrubbing certification process for the application in response to the determination of existence of the agreement. The data store may receive application data associated with the executed application, that it, data that is used and/or created during/by the execution of the application. The application data may be inserted with sentinels. The sentinels may be identifiers with no prior meaning within the data store, for example as generated by a “global unique identifier” algorithm. The data scrubbing certification module may be configured to receive value of the sentinels that are inserted into the application data and use encrypted searching to monitor when those values enter the service's data storage and when they are removed. This may allow the datacenter to observe the ingress and egress of the application data being monitored without allowing the datacenter or anyone else to read the contents of the data. The data scrubbing certification module may be configured to track the sentinel values by executing an encrypted search within the data store for the sentinel values. In some examples, the data store may be encrypted such that a search key is further enabled, which may be registered with the data scrubbing certification module.

The datacenter 102 may further include one or more application programming interfaces (APIs). In some embodiments, the application may call upon (use) at least one of the APIs to register arbitrary and/or pseudo-random sentinel values. The data scrubbing certification module may be configured to generate the random sentinel values, and execute an encrypted search within the data store using the generated sentinel values to determine whether the generated sentinel values are present in the data store. In further embodiments, the application may call upon one or more other APIs to record a time and a date that the application data ingresses to the data store and egresses from the data store.

The data scrubbing certification module may be configured to provide evidence to the application that the service is compliant with the data retention and elimination policy upon verification of the ingress and the egress of the application data to and from the data store. The application may be configured to generate log entries using the provided evidence to document that the application data was successfully ingressed and egressed from the data store. In some examples, the evidence provided by the data scrubbing certification module may include the recorded times and dates that the application was tested to have ingressed to and egressed from the data store, which may further be included in the log entries generated by the application.

Datacenter operators may want to associate platforms comprising sensitive data, such as alternative payments platforms, with existing service providers in order to grow ecosystems of the datacenters. Service providers, whether they are offering business intelligence, semantic mining, social layer processing, or any other function, may like to extend their service offerings to alternative payment platforms, for example, with a minimum of business disruption and re-engineering. Furthermore, alternative payments platforms may want to be able to rapidly build payment systems leveraging existing services of datacenters while maintaining compliance standards set by the financial industry. The above-described embodiments may allow the existing service providers to offer their services to platforms comprising sensitive data, such as the payment and/or medical industries, while enabling an ecosystem of the datacenter 102 to expand. The datacenter 102 may be configured to provide the data retention and elimination policy, including procedures to be enacted by the datacenter service, as a pre-filled form to the service provider. The service provider may agree to the data retention and elimination policy for as much or as little of the service as requested by the service provider. The datacenter 102 may then be able to provide audit evidence that the service is compliant with the data retention and elimination policy without any further modification or effort to be performed and/or executed by the service provider.

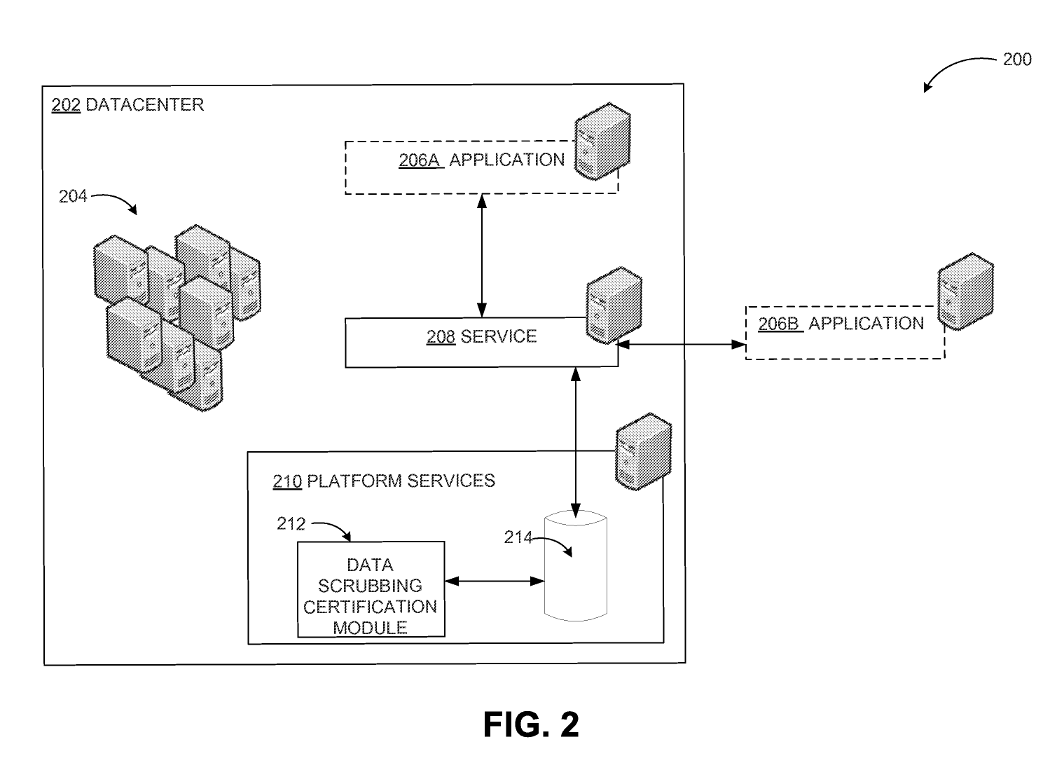

FIG. 2 illustrates a conceptual system where data scrubbing certification may be implemented, arranged in accordance with at least some embodiments described herein.

As shown in a diagram 200, an example system may include a datacenter 202 comprising one or more servers 204, where the servers 204 may be configured to execute or host a service 208 and one or more platform services 210 provided by an operator of the datacenter 202 or a third party service provider, respectively. In one embodiment, the servers 204 may be further configured to execute an application 206A residing at the datacenter 202. In another embodiment, an application 206B may reside outside of the datacenter, where the service 208 may include one or more APIs which the application 206B may call upon. The application 206A or 206B may be a payment application, for example, and may include sensitive data such as payment information. The service 208 may be associated with the application 206A or 206B, and may be configured to store application data within a data store 214 of the datacenter 202. The platform services 210 may include at least one data scrubbing certification module 212 and the data store 214. The data store 214 may be encrypted such that the contents of data store 214 are not able to be seen upon execution of a search without a key. Additionally, the data store encryption may allow use of a search key, which may be registered with the data scrubbing certification module 212 upon activation of a data scrubbing certification process.

Due to the sensitive payment information within the application data, the service 208 may be provided with a data retention and elimination policy, including procedures to be enacted by the platform services 210, as a pre-filled form to which the service 208 may agree. Once the procedures are enacted, the platform services 210 may be configured to provide proof of practice of the data retention and elimination policy (for example, through evidence) to the application 206A or 206B. The proof of practice may indicate that the service 208 is compliant with regulations mandated by the financial industry, for example, when storing the application data within the data store 214.

According to some embodiments, the data scrubbing certification module 212 may be configured to determine that the agreement to the data retention and elimination policy from the service 208 is in existence. In response, the data scrubbing certification module 212 may be configured to activate the data scrubbing certification process for the application 206A or 206B, and the service 208 may continue to store application data within the data store 214.

The application 206B may call upon a first API of the service 208 to register sentinel values. In response, the data scrubbing certification module 212 may be configured to generate or receive arbitrary and/or pseudo-random sentinel values, and may execute a first encrypted search within the data store 214 using the generated sentinel values to determine whether the generated sentinel values are present in the data store. The data scrubbing certification module 212 may be configured to return one or more of the generated sentinel values that are not present in the data store to the application 206B to be inserted as one or more sentinels within the application data. Dependent on a schema of the data store 214, a location where the sentinels are inserted within the application data may be important. For example, if the data store 214 includes rows and columns and/or trees, the sentinels may be inserted at various levels of the data store 214 to achieve optimum coverage. The sentinels may be identifiers with no prior meaning within the data store 214, for example as generated by a “global unique identifier” algorithm. The application 206B may be configured to provide the application data with the inserted sentinels to the service 208 to be stored within the data store 214.

In other embodiments, the application 206A or 206B may call upon a second API of the service 208 to check an ingress to the data store 214. In response, the data scrubbing certification module 212 may be configured to track the sentinels to verify the ingress of the application data to the data store 214. The data scrubbing certification module 212 may track the sentinels by executing a second encrypted search within the data store 214 for the sentinels. For example, the second encrypted search may be executed on a same day when the application 206A or 206B provided the application data with the inserted sentinels to the service 208 to be stored within the data store 214.

In further embodiments, the application 206A or 206B may call upon a third API of the service 208 to check an egress of the application data from the data store 214. In response, the data scrubbing certification module 212 may be configured to track the sentinels to verify the egress of the application data from the data store 214. The data scrubbing certification module 212 may track the sentinels by executing a third encrypted search within the data store 214 for the sentinels to verify they are no longer present in the data store 214. For example, the third encrypted search may be executed when an effort of the service 208 is terminated, for example, about 10 days following the provision of the application data from the application 206A or 206B to the service 208. Additionally, the data scrubbing certification module 212 may be configured to record a time and date the application data ingressed to the data store 214 and a time and date the application data egressed from the data store 214 based on results of the encrypted search.

The data scrubbing certification module 212 may then be configured to provide evidence that the service 208 is compliant with the data retention and elimination policy upon verification of the ingress and the egress of the application data to and from the data store 214. Accordingly, the data scrubbing certification module 212 may verify for the application 206A or 206B that the service 208 has cleaned up internal storage of the service 208 to prevent side channel leakage and/or any ongoing leakage of the sensitive information within the application data. The application may be configured to generate log entries using the provided evidence to document that the application data was successfully ingressed and egressed from the data store such that the application 206A or 206B may be able to pass mandated certifications. In some examples, the evidence provided by the data scrubbing certification module 212 may include the recorded times and dates that the application ingressed to and egressed from the data store, which may further be included in the log entries generated by the application 206A or 206B.

Alternately, in response to a determination that the application data has not egressed from the data store within a specified time period, the data scrubbing certification module 212 may be configured to alert that the data store 214 still includes the application data. For example, if the data scrubbing certification module 212 finds evidence of the sentinels within the data store 214 when executing the third encrypted search for the sentinels, the platform services 210 may be configured to provide encrypted search results back to the service 208. The service 208 may decrypt the results to see what application data may have been forgotten to be cleared and/or removed from the data store 214. In some realizations the results provided back to the service 208 may include indications of which application data or subject data is still detected with or without including the actual sentinel specifics.

In some examples, the service 208 may be associated with multiple users of the application 206A or 206B. Accordingly, the sentinel values within application data may be distinct for each user such that the sentinels inserted within application data of a first user are not also inserted in the application data of a second user, either by random chance or maliciously. To prevent such an occurrence, multiple, (and long) random sentinels may be inserted within the application data for each user to reduce the chance that sentinels inserted within application data of more than one user are the same. Additionally, the service 208 may store application data in separate data stores for each user of the applications and/or the service 208 may provide separate search keys to be registered to each user of the applications to avoid cross-comparison of sentinel values within the data store 214. Although, even if the application 206A or 206B stores application data associated with multiple users within a single data store and/or under a single key and there are multiple sentinel hits, the nature of searchable encryption may allow the data scrubbing certification module 212 to conduct the verification and identify any issues, such as data leakage, without ever seeing the contents of the data store 214.

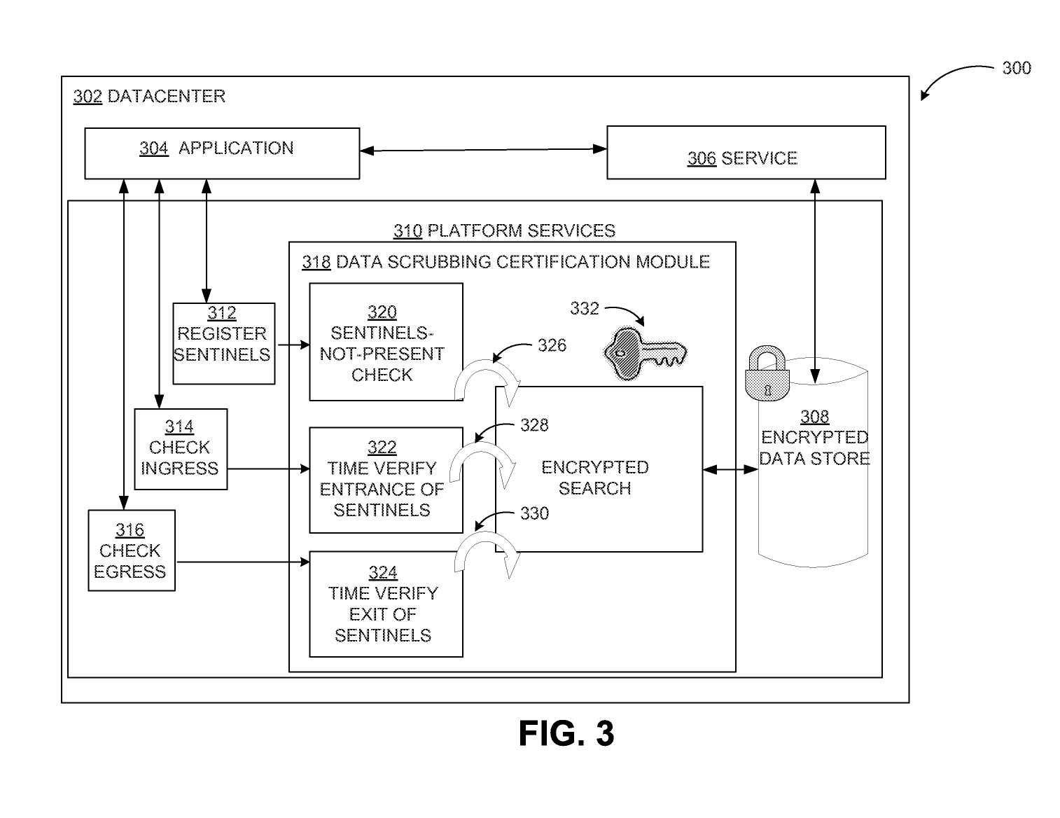

FIG. 3 illustrates an example system to monitor data ingress to and egress from platform provided storage employing data scrubbing certification, arranged in accordance with at least some embodiments described herein.

As shown in a diagram 300, an example system may include a datacenter 302, an application 304 executed within or outside the datacenter 302, a service 306 provided by an operator of the datacenter 302 or by a third party service provider, and one or more platform services 310 provided by a platform and executed at servers of the datacenter 302, including at least one data scrubbing certification module 318 and at least one data store 308. While the application 304 is shown within the datacenter 302 in the figure, the application 304 may be outside any datacenter or hardware commonality with the platform. This is illustrated in FIG. 2 with the two alternative applications 206A and 206B. In the diagram 300, a single application is shown for brevity purposes. The service 306 may be associated with the application 304, and may be configured to store application data within the data store 308, which may be encrypted to enable a search key 332. The search key 332 may be registered with the data scrubbing certification module 318 and may be distinct for each user of the application 304, if there are multiple users of the application 304 associated with the service 306.

In some examples, the application 304 may comprise sensitive data, such as payment and/or health information. Due to the sensitive information within the application data, the service 306 may receive a data retention and elimination policy (for example from the datacenter 302, a tenant of the datacenter 302, or a third party entity), including procedures to be enacted by the platform services 310, to which the service 306 may agree. In some examples, the data retention and elimination policy may be provided to the service 306 as a pre-filled form. Once the procedures are enacted by the platform services 310, proof of practice of the data retention and elimination policy (for example, through evidence) may be provided to the application 304, the service 306, and/or other relevant entity. The proof of practice may indicate that the service 306 is compliant with regulations mandated by industry standards such as the financial or medical industry, for example, when storing the application data within the data store 308.

In response to a determination that the agreement to the data retention and elimination policy from the service 306 is in existence, the data scrubbing certification module 318 may activate a data scrubbing certification process for the application 304. The application 304 may be configured to call upon a first API of the service 306 to register sentinel values at operation 312, and in response, the data scrubbing certification module 318 may be configured to generate sentinel values. The data scrubbing certification module 318 may be configured to execute a first encrypted search at operation 326 within the data store 308 using the generated sentinel values to determine whether the generated sentinel values are present in the data store at operation 320. The data scrubbing certification module 318 may be configured to return one or more of the generated sentinel values that are not present in the data store 308 to the application 304 as one or more sentinels to be inserted within the application data. For example, the sentinels to be inserted may be identifiers with no prior meaning within the data store 308. In some examples, the service 306 may be associated with multiple users of the application 304. Accordingly, the sentinels inserted within application data may be distinct for each user such that the sentinels inserted within application data of a first user are not also inserted in the application data of a second user, either by random chance or maliciously. To prevent such an occurrence, multiple, long, arbitrary sentinels may be inserted within the application data for each user to reduce the chance that sentinels inserted within application data of more than one user are the same. The application 304 may then be configured to provide the application data with the inserted sentinels to the service 306 to be stored within the data store 308.

The application 304 may be configured to call upon a second API of the service 306 to check an ingress at operation 314 of the application data to the data store 308. In response to the call to check the ingress, the data scrubbing certification module 318 may be configured to track the sentinels to verify the ingress of the application data to the data store 308. The data scrubbing certification module 318 may be configured to track the sentinels to verify the ingress of the application data to the data store 308 by executing a second encrypted search at operation 328 for the sentinels within the data store 308. Additionally, the data scrubbing certification module 318 may be configured to record a time and date the application data ingressed at operation 322 from the data store 308 using results from the second encrypted search performed at the operation 328. In some cases the ingress check may be performed by datacenter service 310 automatically over time and logged, instead of being called explicitly by application 304.

The application 306 may call upon a third API of the service 306 to check an egress at operation 316 of the application data from the data store 308. In response to the call to check the egress, the data scrubbing certification module 318 may be configured to track the sentinels to verify the egress of the application data from the data store 308. The data scrubbing certification module 318 may be configured to track the sentinels to verify the egress of the application data from the data store 308 by executing a third encrypted search at operation 330 within the data store 308 for the sentinels to verify they are no longer present in the data store 308. Additionally, the data scrubbing certification module 318 may be configured to record a time and date the application data egressed at operation 324 from the data store 308 using results from the third encrypted search performed at the operation 330.

The data scrubbing certification module 318 may then be configured to provide evidence to the application 304 that the service 306 is compliant with the data retention and elimination policy upon verification of the ingress and egress of the application data to and from the data store 308. The application 304 may be configured to generate or receive log entries that use the provided evidence to document that the application data was successfully ingressed and egressed from the data store such that the application 304 may be able to pass mandated certifications. In some examples, the evidence provided may include the recorded times and dates that the application ingressed to and egressed from the data store 308, which may further be included in the log entries generated by the application 304. Alternately, in response to a determination that the application data has not egressed from the data store within a specified time period, the data scrubbing certification module 318 may be configured to alert the application 304 that the data store 308 comprises the application data.

The examples in FIGS. 1-3 have been described using specific datacenters, configurations, systems, and processes to monitor data ingress to and egress from platform provided storage employing data scrubbing certification. Employment of data scrubbing certification to monitor data ingress to and egress from platform provided storage is not limited to the specific networks, configurations, systems, and processes according to these examples.

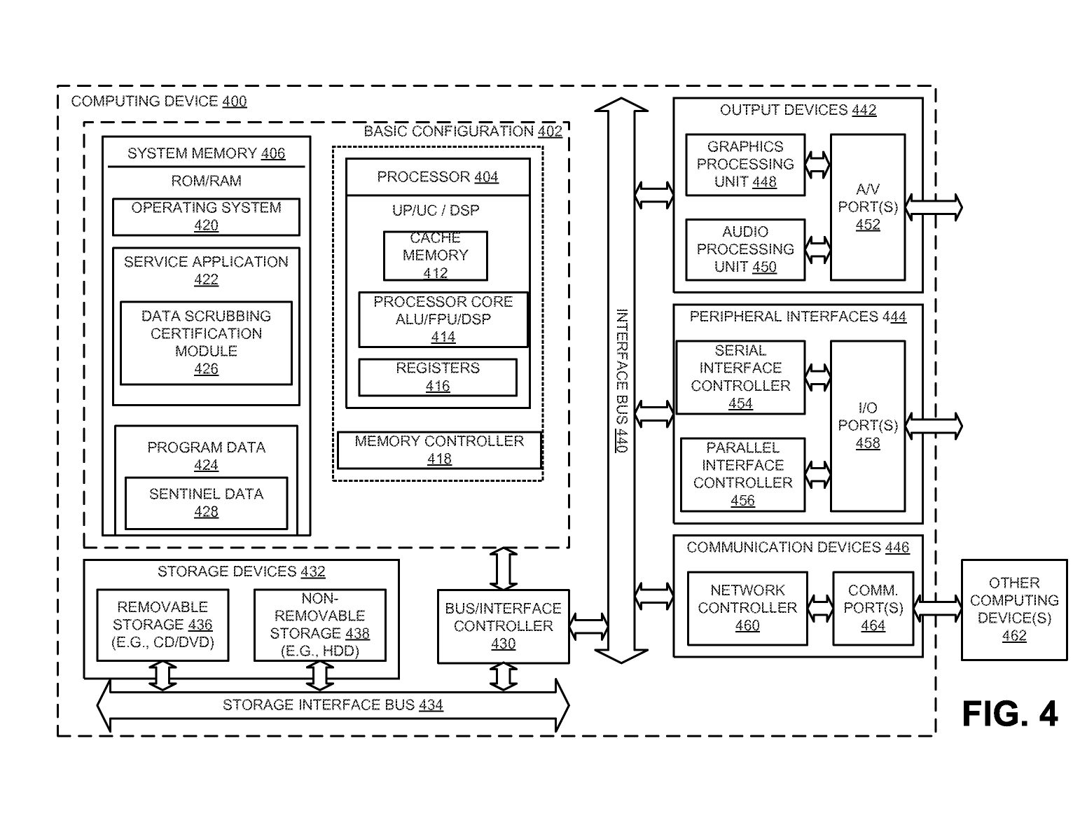

FIG. 4 illustrates a general purpose computing device, which may be used to monitor data ingress to and egress from platform provided storage employing data scrubbing certification, arranged in accordance with at least some embodiments described herein.

For example, a computing device 400 may be used as a server, desktop computer, portable computer, smart phone, special purpose computer, or similar device such as a controller. In an example basic configuration 402, the computing device 400 may include one or more processors 404 and a system memory 406. A memory bus 408 may be used for communicating between the processor 404 and the system memory 406. The basic configuration 402 is illustrated in FIG. 4 by those components within the inner dashed line.

Depending on the desired configuration, the processor 404 may be of any type, including but not limited to a microprocessor (IP), a microcontroller (μC), a digital signal processor (DSP), or any combination thereof. The processor 404 may include one more levels of caching, such as a level cache memory 412, one or more processor cores 414, and registers 416. The example processor cores 414 may (each) include an arithmetic logic unit (ALU), a floating point unit (FPU), a digital signal processing core (DSP Core), or any combination thereof. An example memory controller 418 may also be used with the processor 404, or in some implementations the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, a datacenter service application 422, and program data 424. The datacenter service application 422 may include a data scrubbing certification module 426, which may be an integral part of the application or a separate application on its own. The data scrubbing certification module 426 may be configured to determine an existence of an agreement to a data retention and elimination policy from a service associated with an application executed at the datacenter, where the service may store application data within a data store of the datacenter. The data scrubbing certification module 426 may be configured to activate a data scrubbing certification process for the application, and the data store may receive the application data inserted with one or more sentinels from the service such that the data scrubbing certification module 426 can track the sentinels to verify an ingress and egress of the application data to and from the data store, as described herein. The program data 424 may include, among other data, sentinel data 428, related, among other things, to the sentinels generated and tracked in order to verify the ingress and egress of the application data to and from the data store, as described herein.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more storage devices 432 via a storage interface bus 434. The storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436, and the non-removable storage devices 438 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (for example, one or more output devices 442, one or more peripheral interfaces 444, and one or more communication devices 446) to the basic configuration 402 via the bus/interface controller 430. Some of the example output devices 442 include a graphics processing unit 448 and an audio processing unit 450, which may be configured to communicate to various external devices such as a display or speakers via one or more A/V ports 452. One or more example peripheral interfaces 444 may include a serial interface controller 454 or a parallel interface controller 456, which may be configured to communicate with external devices such as input devices (for example, keyboard, mouse, pen, voice input device, touch input device, etc.) or other peripheral devices (for example, printer, scanner, etc.) via one or more I/O ports 458. An example communication device 446 includes a network controller 460, which may be arranged to facilitate communications with one or more other computing devices 462 over a network communication link via one or more communication ports 464. The one or more other computing devices 462 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a part of a general purpose or specialized server, mainframe, or similar computer that includes any of the above functions. The computing device 400 may also be implemented as a personal computer including both laptop computer and non-laptop computer configurations.

Example embodiments may also include methods to monitor data ingress to and egress from platform provided storage employing data scrubbing certification. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

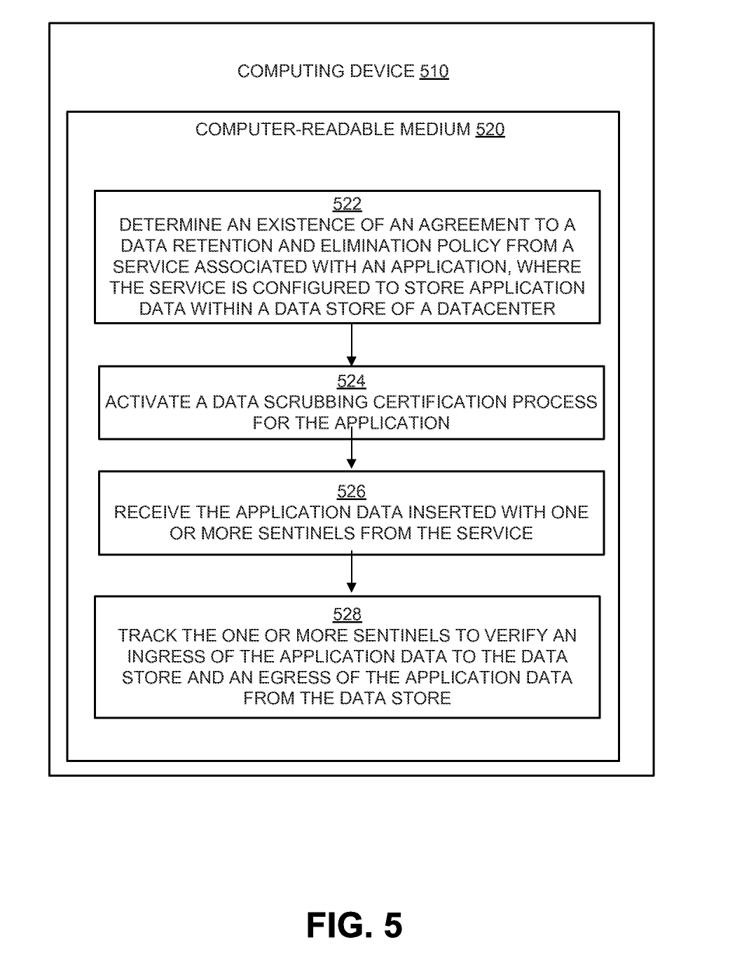

FIG. 5 is a flow diagram illustrating an example process to monitor data ingress to and egress from platform provided storage employing data scrubbing certification that may be performed by a computing device such as the computing device in FIG. 4, arranged in accordance with at least some embodiments described herein.

Example methods may include one or more operations, functions or actions as illustrated by one or more of blocks 522, 524, 526, and/or 528. The operations described in the blocks 522 through 528 may also be stored as computer-executable instructions in a computer-readable medium such as a computer-readable medium 520 of a computing device 510.

An example process to monitor data ingress to and data egress from platform provided storage may begin with block 522, “DETERMINE AN EXISTENCE OF AN AGREEMENT TO A DATA RETENTION AND ELIMINATION POLICY FROM A SERVICE ASSOCIATED WITH AN APPLICATION, WHERE THE SERVICE IS CONFIGURED TO STORE APPLICATION DATA WITHIN A DATA STORE OF A DATACENTER,” where a service (for example, the service 306) may be associated with an application (for example, the application 304) executed within or outside a datacenter (for example, the datacenter 302), and may be configured to store application data within a data store (for example, the data store 308) of the datacenter. The service may be provided by an operator of the datacenter or by a third party service provider, for example. The datacenter may be configured to provide the service provider a data retention and elimination policy, including procedures to be enacted by one or more datacenter services (for example, the platform services 310), the datacenter services including at least one data scrubbing certification module (for example, the data scrubbing certification module 318) and the data store. The service provider may agree to the data retention and elimination policy, and the data scrubbing certification module may be configured to determine an existence of the agreement from the service. In some examples agreement to the data retention and elimination policy may include selecting or activating a data scrubbing service.

Block 522 may be followed by block 524, “ACTIVATE A DATA SCRUBBING CERTIFICATION PROCESS FOR THE APPLICATION,” where the data scrubbing certification module may be configured to activate a data scrubbing certification process for the application in response to the determination of the existence of the agreement to the data retention and elimination policy from the service.

Block 524 may be followed by block 526, “RECEIVE THE APPLICATION DATA INSERTED WITH ONE OR MORE SENTINELS FROM THE SERVICE,” where the application data inserted with one or more sentinels may be received at the data store from the service. Prior to receiving the application data at the data store, the data scrubbing certification module of the datacenter may be configured to generate random sentinel values and execute a first encrypted search (for example, the operation 326) within the data store using the generated sentinel values to determine whether the generated sentinel values are present in the data store (for example, the operation 320). One or more of the generated sentinel values that are not present in the data store to the application may then be returned to the application as the one or more sentinels for insertion within the application data. In other examples the sentinels may be generated and delivered to the data scrubbing certification module externally, such as from the application.

Block 526 may be followed by block 528, “TRACK THE ONE OR MORE SENTINELS TO VERIFY AN INGRESS OF THE APPLICATION DATA TO THE DATA STORE AND AN EGRESS OF THE APPLICATION DATA FROM THE DATA STORE,” where the data scrubbing certification module may be configured to track the sentinels to verify an ingress of the application data to the data store by executing a second encrypted search (for example, the operation 328) for the sentinels within the data store. The data scrubbing certification module may be further configured to track the sentinels to verify an egress of the application data to the data store by executing a third encrypted search (for example, the operation 330) for the sentinels within the data store to verify the sentinels are no longer present in the data store. In some examples, a time and a date that the application data ingresses (for example, the operation 322) to the data store and a time and a date that the application data egresses (for example, the operation 324) from the data store may be recorded by the data scrubbing certification module.

The blocks included in the above described process are for illustration purposes. Employment of data scrubbing certification to monitor data ingress to and egress from platform provided storage may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

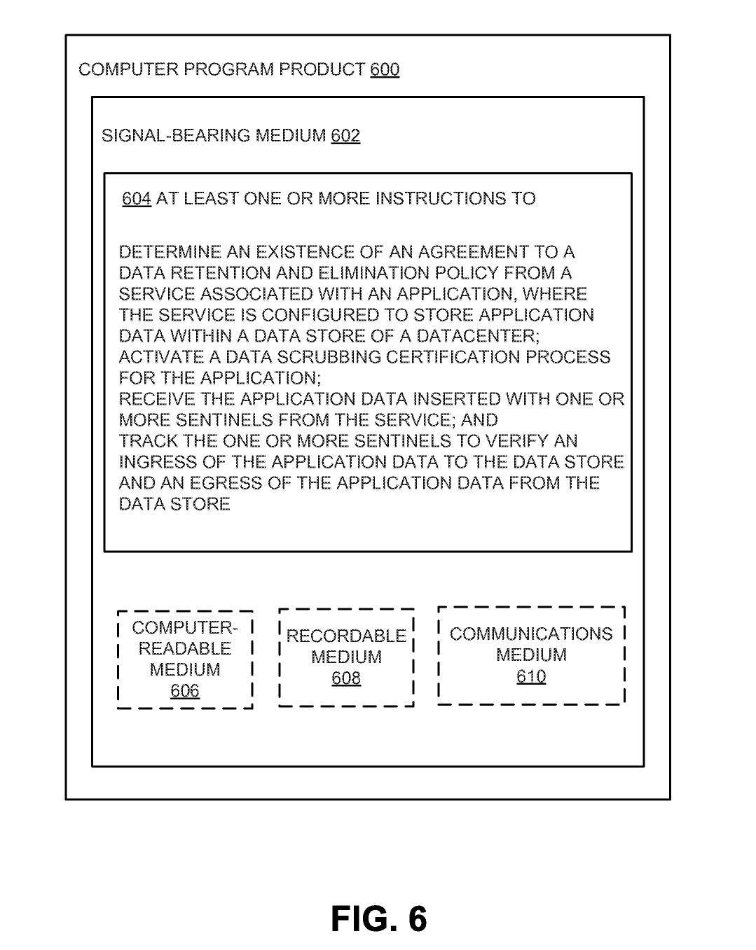

FIG. 6 illustrates a block diagram of an example computer program product, arranged in accordance with at least some embodiments described herein.

In some embodiments, as shown in FIG. 6, the computer program product 600 may include a signal bearing medium 602 that may also include one or more machine readable instructions 604 that, when executed by, for example, a processor, may provide the functionality described herein. Thus, for example, referring to the processor 404 in FIG. 4, a data scrubbing certification module 426 executed on the processor 404 may undertake one or more of the tasks shown in FIG. 6 in response to the instructions 604 conveyed to the processor 404 by the medium 602 to perform actions associated with employment of data scrubbing certification to monitor an ingress and egress of sensitive data to and from platform provided storage. Some of those instructions may include, for example, one or more instructions to determine an existence of an agreement to a data retention and elimination policy from a service associated with an application, where the service is configured to store application data within a data store of a datacenter, activate a data scrubbing certification process for the application, receive the application data inserted with one or more sentinels from the service, and track the one or more sentinels to verify an ingress of the application data to the data store and an egress of the application data from the data store, according to some embodiments described herein.

In some implementations, the signal bearing medium 602 depicted in FIG. 6 may encompass a computer-readable medium 606, such as, but not limited to, a hard disk drive, a solid state drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (for example, a fiber optic cable, a waveguide, a wired communications link, a wireless communication link, etc.). Thus, for example, the program product 600 may be conveyed to one or more modules of the processor 404 of FIG. 4 by an RF signal bearing medium, where the signal bearing medium 602 is conveyed by the wireless communications medium 610 (for example, a wireless communications medium conforming with the IEEE 802.11 standard).

According to examples, methods to monitor data ingress to and data egress from platform provided storage are provided. An example method may include determining an existence of an agreement to a data retention and elimination policy from a service associated with an application, where the service is configured to store application data within a data store of a platform, and activating a data scrubbing certification for the application. The example method may also include receiving the application data inserted with one or more sentinels from the service, and tracking the sentinels to verify an ingress of the application data to the data store and an egress of the application data from the data store.

In other examples, evidence may be provided that the service is compliant with the data retention and elimination policy upon verification of the ingress of the application data to the data store and the egress of the data from the data store. Pseudo-random sentinel values may be generated, and an encrypted search may be executed within the data store for the generated sentinel values to determine whether the generated sentinel values are present in the data store. One or more of the generated sentinel values that are not present in the data store may be returned to the application as the sentinels for insertion within the application data. A time and a date that the application data ingresses to the data store may be recorded. A time and a date that the application data egresses from the data store may be recorded.

In further examples, an encrypted search may be executed within the data store for the more sentinels to track the sentinels to verify the ingress of the application data to the data store and the egress of the data from the data store. A search key may be registered with the data scrubbing certification allowing the encrypted search within the data store for the one or more sentinels. In response to a determination that the application data has not egressed from the data store within a specified time period, the application may be alerted that the data store comprises the application data.

According to some embodiments, systems to monitor data ingress to and data egress from platform provided storage are described. An example system may include an application comprising sensitive data, a service associated with the application, where the service is configured to store application data within a data store of a platform, and a data scrubbing certification module executed at the platform. The data scrubbing certification module may be configured to determine an existence of an agreement to a data retention and elimination policy from the service and activate a data scrubbing certification for the application. The data scrubbing certification module may also be configured to receive the application data inserted with one or more sentinels from the service, and execute an encrypted search within the data store for the sentinels to track the sentinels in order to verify an ingress of the application data to the data store and an egress of the data from the data store. The data scrubbing certification module may further be configured to provide evidence to the application that the service is compliant with the data retention and elimination policy based on the verification.

In other embodiments, the platform may be configured to provide one or more application programming interfaces (APIs). The one or more APIs may be called upon by the application to generate random sentinel values, execute another encrypted search within the data store using the generated sentinel values to determine whether the generated sentinel values are present in the data store, and return one or more of the generated sentinel values that are not present in the data store to the application as the sentinels for insertion within the application data. The one or more APIs may be further called upon by the application to record a time and a date that the application data ingresses to the data store, and record a time and a date that the application data egresses from the data store. The times and dates of the application data ingress and egress may be included in the evidence provided to the application.

In further embodiments, the service may be provided by the platform or a third party service provider. The one or more sentinels may be “global unique identifiers”, GUIDs, where the sentinels are distinct for each user of the application. The application may be configured to generate log entries using the provided evidence to document that the application data was successfully ingressed and egressed from the data store. The application may be a payment application.

According to some examples, systems to monitor data ingress to and data egress from platform provided storage are described. An example platform may include one or more services comprising at least a data scrubbing certification module and a data store. The data scrubbing certification module may be configured to determine an existence of an agreement to a data retention and elimination policy from a service that is associated with an application, where the service is configured to store application data within the data store, and activate a data scrubbing certification for the application. The data scrubbing certification module may also be configured to generate random sentinel values to execute an encrypted search within the data store using the generated sentinel values to determine whether the generated sentinel values are present in the data store, and return one or more of the generated sentinel values that are not present in the data store to the application as one or more sentinels for insertion within the application data. The data scrubbing certification module may be further configured to receive the application data with the sentinels inserted from the service, execute another encrypted search within the data store for the sentinels to track sentinels in order to verify an ingress of the application data to the data store and an egress of the application data from the data store, and provide evidence to the application that the service is compliant with the data retention and elimination policy based on the verification.

In other examples, the data store may be encrypted such that a search key is enabled. The search key may be registered with the data scrubbing certification module. The search key may distinct for each user of the application. The platform may include a single data store for multiple users of the application. The platform may include a separate data store for each user of the application.

There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various compositions, methods, systems, and devices are described in terms of “comprising” various components or steps (interpreted as meaning “including, but not limited to”), the compositions, methods, systems, and devices can also “consist essentially of” or “consist of the various components and steps, and such terminology should be interpreted as defining essentially closed-member groups.”

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be possible in light of this disclosure.

The present disclosure is not to be limited in terms of the particular embodiments described in this application, which are intended as illustrations of various aspects. Many modifications and variations can be made without departing from its spirit and scope Functionally equivalent methods and apparatuses within the scope of the disclosure, in addition to those enumerated herein, will be possible from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to monitor data ingress to and data egress from platform provided storage, the method comprising:
determining an existence of an agreement to a data retention and elimination policy from a service associated with an application, wherein the service is configured to store application data within a data store of a platform;
activating a data scrubbing certification for the application;
receiving the application data inserted with one or more sentinels from the service, wherein the one or more sentinels inserted within the application data are distinct for each user associated with the application data; and
tracking the one or more sentinels to verify an ingress of the application data to the data store and an egress of the application data from the data store.

2. The method of claim 1, further comprising:
providing evidence that the service is compliant with the data retention and elimination policy upon verification of the ingress of the application data to the data store and the egress of the data from the data store.

3. The method of claim 1, further comprising:
generating pseudo-random sentinel values.

4. The method of claim 3, further comprising:
executing an encrypted search within the data store for the generated sentinel values to determine whether the generated sentinel values are present in the data store.

5. The method of claim 4, further comprising:
returning one or more of the generated sentinel values that are not present in the data store to the application as the one or more sentinels for insertion within the application data.

6. The method of claim 1, further comprising:
recording a time and a date that the application data ingresses to the data store; and
recording a time and a date that the application data egresses from the data store.

7. (canceled)

8. The method of claim 1, wherein tracking the one or more sentinels to verify an ingress of the application data to the data store and an egress of the data from the data store further comprises:
executing an encrypted search within the data store for the one or more sentinels.

9. The method of claim 8, further comprising:
registering a search key with the data scrubbing certification allowing the encrypted search within the data store for the one or more sentinels.

10. The method of claim 1, further comprising:
in response to a determination that the application data has not egressed from the data store within a specified time period, alerting the application that the data store comprises the application data.

11. A system to monitor data ingress to and data egress from platform provided storage, the system comprising:
an application comprising sensitive data;
a service associated with the application, wherein the service is configured to store application data within a data store of the platform; and
a data scrubbing certification module executed at the platform, wherein the data scrubbing certification module is configured to:
determine an existence of an agreement to a data retention and elimination policy from the service;
activate a data scrubbing certification for the application;
receive the application data inserted with one or more sentinels from the service, wherein the one or more sentinels inserted within the application data are distinct for each user associated with the application data;
execute an encrypted search within the data store for the one or more sentinels to track the one or more sentinels in order to verify an ingress of the application data to the data store and an egress of the data from the data store; and
provide evidence to the application that the service is compliant with the data retention and elimination policy based on the verification.

12. The system of claim 11, wherein the platform is configured to provide one or more application programming interfaces (APIs).

13. The system of claim 12, wherein the one or more APIs are called upon by the application to:
generate random sentinel values;
execute another encrypted search within the data store using the generated sentinel values to determine whether the generated sentinel values are present in the data store; and
return one or more of the generated sentinel values that are not present in the data store to the application as the one or more sentinels for insertion within the application data.

14. The system of claim 12, the one or more APIs are further called upon by the application to:
record a time and a date that the application data ingresses to the data store; and
record a time and a date that the application data egresses from the data store.

15. The system of claim 14, wherein the times and dates of the application data ingress and egress are included in the evidence provided to the application.

16. The system of claim 11, wherein the service is provided by the platform or a third party service provider.

17.-18. (canceled)

19. The system of claim 11, wherein the application is configured to generate log entries using the provided evidence to document that the application data was successfully ingressed and egressed from the data store.

20. The system of claim 11, wherein the application is a payment application.

21. A platform to monitor data ingress to and data egress from platform provided storage, the platform comprising:
one or more services comprising at least a data scrubbing certification module and a data store, the data scrubbing certification module configured to:
determine an existence of an agreement to a data retention and elimination policy from a service that is associated with an application, wherein the service is configured to store application data within the data store;
activate a data scrubbing certification for the application;
generate random sentinel values to execute an encrypted search within the data store using the generated sentinel values to determine whether the generated sentinel values are present in the data store;
return one or more of the generated sentinel values that are not present in the data store to the application as one or more sentinels for insertion within the application data;
receive the application data with the one or more sentinels inserted from the service, wherein the one or more sentinels inserted within the application data are distinct for each user associated with the application data;
execute another encrypted search within the data store for the one or more sentinels to track the one or more sentinels in order to verify an ingress of the application data to the data store and an egress of the application data from the data store; and
provide evidence to the application that the service is compliant with the data retention and elimination policy based on the verification.

22. The platform of claim 21, wherein the data store is encrypted such that a search key is enabled.

23. (canceled)

24. The platform of claim 22, wherein the search key is distinct for each user of the application.

25.-26. (canceled)
